(19) United States
(12) Patent Application Publication
(10) Pub. No.: US 2012/0222412 A1
(43) Pub. Date: Sep. 6, 2012

(54) Engine Exhaust Gas Particulate Filter having Helically Configured Cells

(75) Inventor: Gerald W. Askew, Fort Wayne, IN (US)

(73) Assignee: International Truck Intellectual Property Company, LLC, Warrenville, IL (US)

(21) Appl. No.: 13/038,909

(22) Filed: Mar. 2, 2011

(51) Int. Cl. F01N 3/02; B01D 46/00

(52) U.S. Cl. 60/311; 55/476

(57) ABSTRACT

An engine exhaust gas particulate filter comprises a plurality of paired longitudinal flow cells having a first flow cell channel and a second flow cell channel. The first flow cell channel is disposed in fluid communication with the second flow cell channel through a common permeable filtration wall. Each of the plurality of paired longitudinal flow cells forms a non-linear flow path about a longitudinal axis of the engine exhaust gas particulate filter.

### TECHNICAL FIELD

The present patent relates to engine exhaust gas particulate filters, and more particularly to an engine exhaust gas particulate filter having helically configured cells.

### BACKGROUND OF THE INVENTION

Many factors, including environmental responsibility efforts and modern environmental regulations on engine exhaust emissions have reduced the allowable acceptable levels of certain pollutants that enter the atmosphere following the combustion of fossil fuels. Increasingly more stringent emission standards may require greater control over either or both the combustion of fuel and post combustion treatment of the exhaust. For example, the allowable levels of nitrogen oxides (NOx) and particulate matter have been greatly reduced over the last several years. To address, among other issues, environmental concerns, many diesel engines now have an exhaust gas particulate filter within an exhaust system of the engine purposed to reduce the amount of particulate matter released into the atmosphere. An engine exhaust gas particulate filter typically has a plurality of paired longitudinal flow cell channels where a first flow cell channel of the pair has an open end at a first end and a closed end at a second end, while the second flow cell channel of the pair has an open end at the second end and a closed end at the first end. A common permeable filtration wall between the first flow cell channel and the second flow cell channel permits filtered fluid communication between the first flow cell channel and the second flow cell channel. Pairs of longitudinal flow cell channels may be arranged in an alternating checkerboard pattern, such that each first flow cell channels having an open first end and closed second end is bounded on each of its four longitudinal sides by second flow cell channels having a closed first end and open second end, the common walls between each flow cell channel being permeable to permit filtered fluid communication between each first flow cell channel and each second flow cell channel.

In order to clean out an engine exhaust gas particulate filter to keep it operating at an effective level and to reduce back pressure that may build up when the engine exhaust gas particulate filter becomes clogged, an engine may be instructed by an engine control module to perform a regeneration cycle upon the engine exhaust gas particulate filter that causes exhaust gas temperatures to rise to a level sufficient to regenerate the engine exhaust gas particulate filter by burning away trapped particulate matter. However, the regeneration cycle generates ash within the engine exhaust gas particulate filter that accumulates over time to a level that adversely impacts performance of the engine exhaust gas particulate filter, and the engine. When a sufficient quantity of ash and particulate matter is present within the engine exhaust gas particulate filter, the engine exhaust gas particulate filter is cleaned by reversing air flow through the engine exhaust gas particulate filter. That is, air enters the second open end of the second flow cell channel of each of the pair of flow cells, and passes through the common permeable filtration wall into the first flow cell channel to remove ash and particulate matter from the first flow cell channel by blowing it out of the first open end of the first flow cell channel. However, as ash and other trapped particulate matter tends to accumulate towards the second closed end of the first flow cell channel, and as little air passes from the second flow cell channel to the first flow cell channel in the area of the second closed end of the first flow cell channel as compared to the volume of air that passes through the entire length of the common permeable filtration wall, the resultant air velocity is low in the region of maximum ash accumulation and the cleaning of the first flow cell channel may not be as complete as desired.

Therefore a need exists for an engine exhaust gas particulate filter that allows for more complete cleaning by maximizing the flow of air through the engine exhaust gas particulate filter in the region where the accumulation of ash is the greatest.

### SUMMARY OF THE INVENTION

According to one embodiment, an engine exhaust gas particulate filter comprises a plurality of paired longitudinal flow cells, each of the plurality of paired longitudinal flow cells having a first flow cell channel and a second flow cell channel. The first flow cell channel is disposed in fluid communication with the second flow cell channel through a common permeable filtration wall. Further, each of the plurality of paired longitudinal flow cells forms a non-linear flow path about a longitudinal axis of the engine exhaust gas particulate filter.

According to another embodiment, each of a plurality of paired longitudinal flow cells disposed in an engine exhaust gas particulate filter has a proximal end and a distal end. Each of the paired longitudinal flow cells comprises a first flow cell channel, a second flow cell channel, and a common permeable filtration wall between the first flow cell channel and the second flow cell channel. The first flow cell channel has a first open end at the proximal end of the engine exhaust gas particulate filter and a second closed end at the distal end of the engine exhaust gas particulate filter. The second flow cell channel has a second open end at the distal end of the engine exhaust gas particulate filter and a first closed end at the proximal end of the engine exhaust gas particulate filter. A common permeable filtration wall is disposed between the first flow cell channel and the second flow cell channel. Further, the first flow cell channel and the second flow cell channel have a non-linear shape.

According to a further embodiment, an engine exhaust gas particulate filter comprises a first flow cell channel, a second flow cell channel, and a common permeable filtration wall. The first flow cell channel has a first open end at a proximal end of the engine exhaust gas particulate filter. The second flow cell channel has a second open end at a distal end of the engine exhaust gas particulate filter. A common permeable filtration wall separates the first flow cell channel from the second flow cell channel and provides fluid communication between the first flow cell channel and the second flow cell channel. Further, the first flow cell channel and the second flow cell channel form a generally helical shape about a longitudinal axis from the proximal end to the distal end of the engine exhaust gas particulate filter.

As described above, the Engine Exhaust Gas Particulate Filter having Helically Configured Cells and a vehicle made with this device provide a number of advantages, some of which have been described above and others of which are inherent in the invention. Also, modifications may be proposed to the Engine Exhaust Gas Particulate Filter having Helically Configured Cells or a vehicle made with this device without departing from the teachings herein.

### BRIEF DESCRIPTION OF THE DRAWINGS

FIG. 1 is a schematic view of an engine exhaust gas particulate filter according to one embodiment.

FIG. 2 is a schematic view of fluid flow in a pair of flow cells of a prior art engine exhaust gas particulate filter.

FIG. 3 is schematic view of particulate matter distribution in a pair of flow cells of a prior art engine exhaust gas particulate filter.

FIG. 4 is a schematic view of fluid flow in a pair of flow cells of an engine exhaust gas particulate filter according to one embodiment.

FIG. 5 is schematic view of particulate matter distribution in a pair of flow cells of an engine exhaust gas particulate filter according to one embodiment.

### DETAILED DESCRIPTION

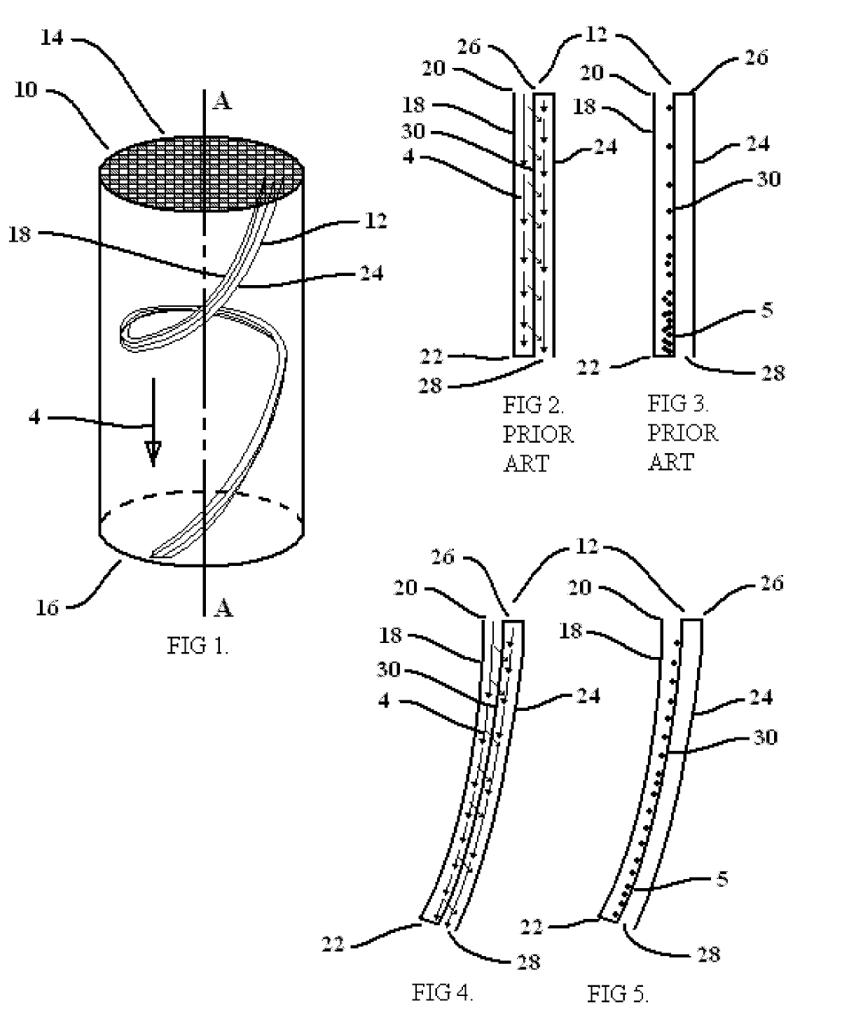

FIG. 1 depicts an engine exhaust gas particulate filter 10 having a plurality of paired longitudinal flow cells 12. Each of the plurality of paired longitudinal flow cells 12 has a first flow cell channel 18 and a second flow cell channel 24. The paired longitudinal flow cells 12 have a non-linear shape, such as a curved shape or a helical shape. Further, the length of the paired longitudinal flow cells 12 may describe at least one full revolution along a longitudinal axis A-A. Alternately, the paired longitudinal flow cells 12 may form a plurality of curves having more than one revolution along the longitudinal axis A-A. The curve of the paired longitudinal flow cells 12 about the longitudinal axis A-A may be generally helically shaped. The curve along the length of the paired longitudinal flow cells 12 produces centripetal acceleration of the engine exhaust gas 4 flowing within the first flow cell channel 18 and the second flow cell channel 24.

The centripetal acceleration caused within the paired longitudinal flow cells 12 results in more even precipitation of particulate matter 5 out of the engine exhaust gas 4 along the common permeable filtration wall 30 separating the first flow cell channel 18 and the second flow cell channel 24, due to cyclonic separation. Further, the helical shape of the longitudinal flow cells 12 causes a more rapid transition to turbulent flow along the length of the first flow cell channel 18, thereby causing entrained particulate matter 5 to precipitate out of the engine exhaust gas flow 4 closer to the first open end 20 of the first flow cell channel 18.

FIG. 2 shows a schematic sectional view of a paired longitudinal flow cell 12 of the prior art configuration. A common permeable filtration wall 30 separates a first flow cell channel 18 from a second flow cell channel 24. The common permeable filtration wall 30 allows fluid communication between the first flow cell channel 18 and the second flow cell channel 24, but disallows the passage of trapped particulate matter 5. The first flow cell channel 18 has a first open end 20 and a second closed end 22. The first open end 20 of the first flow cell channel 18 is disposed at a proximal end 14 of the engine exhaust gas particulate filter 10, and the second closed end 22 of the first flow cell channel 18 is disposed at a distal end 16 of the engine exhaust gas particulate filter 10. The second flow cell channel 24 has a first closed end 26 and a second open end 28. The first closed end 26 of the second flow cell channel 24 is disposed at a proximal end 14 of the engine exhaust gas particulate filter 10, and the second open end 28 of the second flow cell channel 24 is disposed at a distal end 16 of the engine exhaust gas particulate filter 10. Engine exhaust gas 4 enters first flow cell channel 18 at first open end 20, travels the length of first flow cell channel 18 while progressively passing through common permeable filtration wall 30 into the second flow cell channel 24, and then exits the second flow cell channel 24 at second open end 28. Note that the length of the arrows indicating engine exhaust gas flow 4 represents the relative velocity of engine exhaust gas flow 4. Thus, it is shown that engine exhaust gas flow 4 in first flow cell channel 18 is proportionately faster near first open end 20, and slows considerably as it approaches second closed end 22.

FIG. 3 shows a schematic sectional view of the same paired longitudinal flow cell 12 of the prior art configuration as the paired longitudinal flow cell 12 shown in FIG. 2. FIG. 3 further shows the distribution of deposition of trapped particulate matter 5 resulting from engine exhaust gas flow 4 in the first flow cell channel 18. Because the flow rate of the engine exhaust gas 4 is greater near the first open end 20, the majority of the trapped particulate matter 5 is carried deeper into the first flow cell channel 18 and deposited near the second closed end 22. This happens at least partially because the flow near the first open end 20 is laminar and non-turbulent, without any tangential impingement of the trapped particulate matter 5 against the common permeable filtration wall 30. When the engine exhaust gas particulate filter 10 requires cleaning, a reverse gas flow through the paired longitudinal flow cells 12 is used to remove the accumulated trapped particulate matter 5. The reverse gas flow enters the second flow cell channel 24 at the second open end 28, travels the length of the second flow cell channel 24 while progressively passing through common permeable filtration wall 30 into the first flow cell channel 18, and then exits the first flow cell channel 18 at first open end 20. It may be appreciated that the reverse gas flow exiting the first flow cell channel 18 is proportionately slower near the second closed end 22 than at the first open end 20. As a result, the reverse gas flow is least effective near the second closed end 22 where the accumulation of trapped particulate matter 5 is greatest.

FIG. 4 shows a schematic sectional view of a paired longitudinal flow cell 12 of one embodiment of the invention. As in the prior art, a common permeable filtration wall 30 separates a first flow cell channel 18 from a second flow cell channel 24. The common permeable filtration wall 30 allows fluid communication between the first flow cell channel 18 and the second flow cell channel 24, but disallows the passage of trapped particulate matter 5. The first flow cell channel 18 has a first open end 20 and a second closed end 22. The first open end 20 of the first flow cell channel 18 is disposed at a proximal end 14 of the engine exhaust gas particulate filter 10, and the second closed end 22 of the first flow cell channel 18 is disposed at a distal end 16 of the engine exhaust gas particulate filter 10. The second flow cell channel 24 has a first closed end 26 and a second open end 28. The first closed end 26 of the second flow cell channel 24 is disposed at a proximal end 14 of the engine exhaust gas particulate filter 10, and the second open end 28 of the second flow cell channel 24 is disposed at a distal end 16 of the engine exhaust gas particulate filter 10. Engine exhaust gas 4 enters first flow cell channel 18 at first open end 20, travels the length of first flow cell channel 18 while progressively passing through common permeable filtration wall 30 into the second flow cell channel 24, and then exits the second flow cell channel 24 at second open end 28. Unlike the prior art, the paired longitudinal flow cell 12 is non-linear, and bends toward the first flow cell channel 18 along its length. This bend may be compound such that centripetal acceleration of the engine exhaust gas flow 4 may start out perpendicular to the common permeable filtration wall 30, and then transition along the length of the paired longitudinal flow cell 12 from being perpendicular to the common permeable filtration wall 30 to being perpendicular to a common permeable filtration wall separating the first flow cell channel 18 of the paired longitudinal flow cell 12 shown from a second flow cell channel 24 of an adjacent paired longitudinal flow cell 12 (not shown). This bend may also be of increasing or decreasing radius along the length of the paired longitudinal flow cells 12.

FIG. 5 shows a schematic sectional view of the same paired longitudinal flow cell 12 of the embodiment of the invention as the paired longitudinal flow cell 12 shown in FIG. 4. FIG. 5 further shows the distribution of deposition of trapped particulate matter 5 resulting from engine exhaust gas flow 4 in the first flow cell channel 18. Because of the non-linear nature of the paired longitudinal flow cell 12, trapped particulate matter 5 is more evenly distributed along the length of the common permeable filtration wall 30 separating the first flow cell channel 18 from the second flow cell channel 24. This is due to centripetal acceleration of the engine exhaust gas flow 4 resulting in cyclonic separation of the trapped particulate matter 5 from the engine exhaust gas flow 4. It is also due to a more rapid transition of the engine exhaust gas flow 4 to turbulent flow after entering the first flow cell channel 18 at the first open end 20. The more rapid onset of turbulent flow of the engine exhaust gas flow 4 results in earlier precipitation of particulate matter 5, which attaches to the common permeable filtration wall 30 closer to the first open end 20 of the first flow cell channel 18.

Again, when the engine exhaust gas particulate filter 10 requires cleaning, a reverse gas flow through the paired longitudinal flow cells 12 is used to remove the accumulated trapped particulate matter 5. As with the prior art, the reverse gas flow enters the second flow cell channel 24 at the second open end 28, travels the length of the second flow cell channel 24 while progressively passing through common permeable filtration wall 30 into the first flow cell channel 18, and then exits the first flow cell channel 18 at first open end 20. However, because of the deposition of accumulated trapped particulate matter 5 being closer to the first open end 20 of the first flow cell channel 18 that is characteristic of paired longitudinal flow cells 12 having a non-linear shape, the flow velocity of the reverse gas flow is more effective near the first open end 20 where accumulation of the trapped particulate matter 5 is greater than in the prior art.

While specific embodiments have been described in detail in the foregoing detailed description and illustrated in the accompanying drawings, those with ordinary skill in the art will appreciate that various permutations of the invention are possible without departing from the teachings disclosed herein. Accordingly, the particular arrangements disclosed are meant to be illustrative only and not limiting as to the scope of the invention, which is to be given the full breadth of the appended claims and any and all equivalents thereof. Other advantages to an Engine Exhaust Gas Particulate Filter having Helically Configured Cells and a vehicle made with this system may also be inherent in the invention, without having been described above.

What is claimed is:

1. An engine exhaust gas particulate filter comprising:
a plurality of paired longitudinal flow cells having a first flow cell channel and a second flow cell channel, the first flow cell channel being disposed in fluid communication with the second flow cell channel via a common permeable filtration wall;
wherein each of the plurality of paired longitudinal flow cells forms a non-linear shape about a longitudinal axis of the engine exhaust gas particulate filter.

2. The engine exhaust gas particulate filter of claim 1, wherein:
the first flow cell channel has a first open end at a proximal end of the engine exhaust gas particulate filter, and a second closed end at a distal end of the engine exhaust gas particulate filter.

3. The engine exhaust gas particulate filter of claim 1, wherein:
the second flow cell channel has a first closed end at a proximal end of the engine exhaust gas particulate filter, and a second open end at a distal end of the engine exhaust gas particulate filter.

4. The engine exhaust gas particulate filter of claim 1, wherein:
the non-linear shape is a generally helical shape.

5. The engine exhaust gas particulate filter of claim 1, wherein:
the non-linear shape is a compound bend.

6. The engine exhaust gas particulate filter of claim 1, wherein:
the non-linear shape is an increasing radius bend.

7. The engine exhaust gas particulate filter of claim 1, wherein:
the non-linear shape is a decreasing radius bend.

8. The engine exhaust gas particulate filter of claim 1, wherein:
the non-linear shape is a decreasing radius compound bend having a generally helical shape.

9. An exhaust system comprising:
an engine exhaust gas particulate filter having a plurality of paired longitudinal flow cells, each of the plurality of paired longitudinal flow cells having a first flow cell channel and a second flow cell channel, the first flow cell channel being disposed in fluid communication with the second flow cell channel via a common permeable filtration wall;
wherein each of the plurality of paired longitudinal flow cells forms a non-linear shape about a longitudinal axis of the engine exhaust gas particulate filter.

10. The exhaust system of claim 9, wherein:
the first flow cell channel has a first open end at a proximal end of the engine exhaust gas particulate filter, and a second closed end at a distal end of the engine exhaust gas particulate filter.

12. The exhaust system of claim 9, wherein:
the second flow cell channel has a first closed end at a proximal end of the engine exhaust gas particulate filter, and a second open end at a distal end of the engine exhaust gas particulate filter.

13. The exhaust system of claim 9, wherein:
the non-linear shape is a generally helical shape.

14. The exhaust system of claim 9, wherein:
the non-linear shape is a compound bend.

15. The exhaust system of claim 9, wherein:
the non-linear shape is an increasing radius bend.

16. The exhaust system of claim 9, wherein:
the non-linear shape is a decreasing radius bend.

17. The exhaust system of claim 9, wherein:
the non-linear shape is a decreasing radius compound bend having a generally helical shape.

18. A vehicle comprising:
an exhaust system having an engine exhaust gas particulate filter having a plurality of paired longitudinal flow cells, each of the plurality of paired longitudinal flow cells having a first flow cell channel and a second flow cell channel, the first flow cell channel being disposed in fluid communication with the second flow cell channel via a common permeable filtration wall;
the first flow cell channel having a first open end at a proximal end of the engine exhaust gas particulate filter, and a second closed end at a distal end of the engine exhaust gas particulate filter;
the second flow cell channel having a first closed end at a proximal end of the engine exhaust gas particulate filter, and a second open end at a distal end of the engine exhaust gas particulate filter
wherein each of the plurality of paired longitudinal flow cells forms a non-linear shape about a longitudinal axis of the engine exhaust gas particulate filter.

19. The vehicle of claim 18, wherein:
the non-linear shape is a generally helical shape.

20. The vehicle of claim 18, wherein:
the non-linear shape is a compound bend.
